(19) United States
(12) Patent Application Publication
(10) Pub. No.: US 2018/0037400 A1
(43) Pub. Date: Feb. 8, 2018

(54) AEROSOL DISCHARGE ASSEMBLY

(71) Applicant: Plews, Inc., Dixon, IL (US)

(72) Inventor: Toby Kuntzelman, Pecatonica, IL (US)

(21) Appl. No.: 15/231,004

(22) Filed: Aug. 8, 2016

(51) Int. Cl. B65D 83/14; B65D 83/22; B29C 73/02; B65D 83/20

(52) U.S. Cl. CPC B65D 83/753; B65D 83/205; B65D 83/22; B65D 83/756; B29C 73/025

(57) ABSTRACT

An aerosol discharge assembly including an aerosol cap sized to frictionally fit atop a cylindrically-shaped aerosol can having a centrally located longitudinal axis and circular cross-section, the cylindrically-shaped aerosol can containing a pressurized fluid therein and a valve stem which, when depressed, discharges fluid there through. The aerosol cap is also cylindrically shaped having a longitudinal axis coextensive with the longitudinal axis of the cylindrically-shaped aerosol can. The aerosol cap further includes an open channel located along its longitudinal axis exposing the valve stem there through and a hose receiving channel exposed atop the aerosol cap. An actuator is sized to slip fit within the open channel and to slide within it when being depressed by a user, the actuator including a fluid inlet port sized to receive the valve stem and a fluid output port in fluid communication with the fluid inlet port such that when the actuator is depressed, pressurized fluid from the aerosol can is caused to enter the fluid inlet port, travel through the actuator and discharge through the fluid outlet port. The assembly also includes a flexible hose having a first end and a second end, the first end being sized to capture the fluid outlet port, the second end including a fixture for passing the pressurized fluid there through, the flexible hose being sized to frictionally fit within the hose receiving channel when not in use, the assembly also including a safety tab positioned atop and emanating from the actuator which when in place, prevents the actuator from being depressed within the open channel.

### TECHNICAL FIELD

The present invention involves an aerosol discharge assembly which includes an aerosol cap and actuator which, together with a suitable discharge hose and safety tab is ideally suited for the shipment, storage and retail display of an aerosol-based fluid such as a tire sealant. The present invention prevents the accidental discharge of the fluid through a flexible tube which, when not in use, conveniently fits within and is frictionally retained by the aerosol cap. This assembly, as noted, not only prevents accidental discharge of the aerosol fluid but further prevents the loss or damage of the flexible tube when not in use.

### BACKGROUND OF THE INVENTION

Aerosol-based fluids, such as tire sealants, although commonly sold at retail present challenges not only during shipment but also when on retail display. Nevertheless, aerosol-based tire sealants provide a consumer with numerous advantages should one experience a flat tire and, as such, aerosol cans containing tire sealant are quite popular.

One of the significant advantages in using an aerosol can-based tire sealant is that a user simply attaches the nozzle generally located at the end of a flexible hose or tube to the tire valve stem and releases the contents into the tire. The contents are propelled to the puncture and, as a result, creates a seal allowing the driver to proceed without removing the tire. This is obviously appealing for those who do not wish to take the time to remove the flat tire and replace it with a spare noting that the application of a sealant takes only several minutes. However, as noted above, the shipment, storage and retail display of aerosol can-based fluids and particularly tire sealants must be approached cautiously.

Tire sealants, by their general nature, are viscous fluids which are difficult to remove if the aerosol can is inadvertently discharged at any point along the chain of manufacture, shipment and sale. If the can was to inadvertently discharge, adjacent cans and surfaces may be soiled and incapable of being cleaned. Thus, during shipment, if one was to inadvertently depress the can's valve stem resulting in fluid discharge, a number of adjacently packaged cans would, in all likelihood, require disposal.

In addition, aerosol can-based tire sealants require the use of a tube or hose to enable a user to direct the sealant from the can to the tire's valve stem. It is not uncommon to experience loss or damage to the tube or hose during shipment, storage and at retail display. Tubes are hoses are often times taped to the side of the can body which exposes them to potential abuse as well as preventing optimal can packing during shipment.

It is thus an object of the present invention to provide an aerosol discharge assembly which overcomes the limitations recited above.

It is yet a further object to provide an aerosol discharge assembly particularly useful when dealing with aerosol can-based tire sealants which prevents inadvertent discharge as well as protects a suitably placed outlet tube or hose from damage or loss.

These and further objects be more readily apparent when considering the following disclosure and appended claims.

### SUMMARY OF THE INVENTION

An aerosol discharge assembly comprising:
An aerosol cap sized to frictionally fit atop a cylindrically-shaped aerosol can having a centrally located longitudinal axis and circular cross-section, said cylindrically-shaped aerosol can containing a pressurized fluid therein and a valve stem which, when depressed, discharges said fluid there through, said aerosol cap being cylindrically-shaped having a longitudinal axis coextensive with the longitudinal axis of said cylindrically-shaped aerosol can and a circular cross-section, said aerosol cap further comprising an open channel located along said longitudinal axis exposing said valve stem there through and a hose receiving channel exposed atop said aerosol cap;
an actuator sized to slip fit within said open channel and to slide within said open channel when being depressed by a user, said actuator comprising a fluid inlet port sized to frictionally fit said valve stem once said actuator is depressed and a fluid output port in fluid communication with said fluid inlet port such that when said actuator is depressed, pressurized fluid from said aerosol can is caused to enter said fluid inlet port, travel through said actuator and discharge through said fluid outlet port;
a flexible hose having a first end and a second end, said first end being sized to capture said fluid outlet port, said second end comprising a fixture for passing said pressurized fluid there through, said flexible hose being sized to frictionally fit within said hose receiving channel when not in use; and
a safety tab positioned atop and emanating from said actuator which, when in place, prevents said actuator from being depressed within said open channel.

In combination, a tire sealant and aerosol discharge assembly, said combination comprising:
An aerosol cap sized to frictionally fit atop a cylindrically-shaped aerosol can having a centrally located longitudinal axis and circular cross-section, said cylindrically-shaped aerosol can containing a pressurized tire sealant therein and a valve stem which, when depressed, discharges said tire sealant there through, said aerosol cap being cylindrically-shaped having a longitudinal axis coextensive with the longitudinal axis of said cylindrically-shaped aerosol can and a circular cross-section, said aerosol cap further comprising an open channel located along said longitudinal axis exposing said valve stem there through and a hose receiving channel exposed atop said aerosol cap;
an actuator sized to slip fit within said open channel and to slide within said open channel when being depressed by a user, said actuator comprising a fluid inlet port sized to frictionally fit said valve stem once said actuator is depressed and a fluid output port in fluid communication with said fluid inlet port such that when said actuator is depressed, pressurized tire sealant from said aerosol can is caused to enter said fluid inlet port, travel through said actuator and discharge through said fluid outlet port;
a flexible hose having a first end and a second end, said first end being sized to capture said fluid outlet port, said second end comprising a tire valve actuator for passing said pressurized tire sealant there through, said flexible hose being sized to frictionally fit within said hose receiving channel when not in use; and
a safety tab positioned atop and emanating from said aerosol cap which, when in place, prevents said actuator from being depressed within said open channel.

### BRIEF DESCRIPTION OF THE FIGURES

FIG. 1 is a perspective view of the aerosol discharge assembly of the present invention showing its placement atop an aerosol can.

FIG. 2 is a perspective view of the aerosol discharge assembly of FIG. 1.

FIG. 3 is a perspective view of the aerosol discharge assembly of FIG. 2 showing the in-use orientation of the invention's flexible discharge hose.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

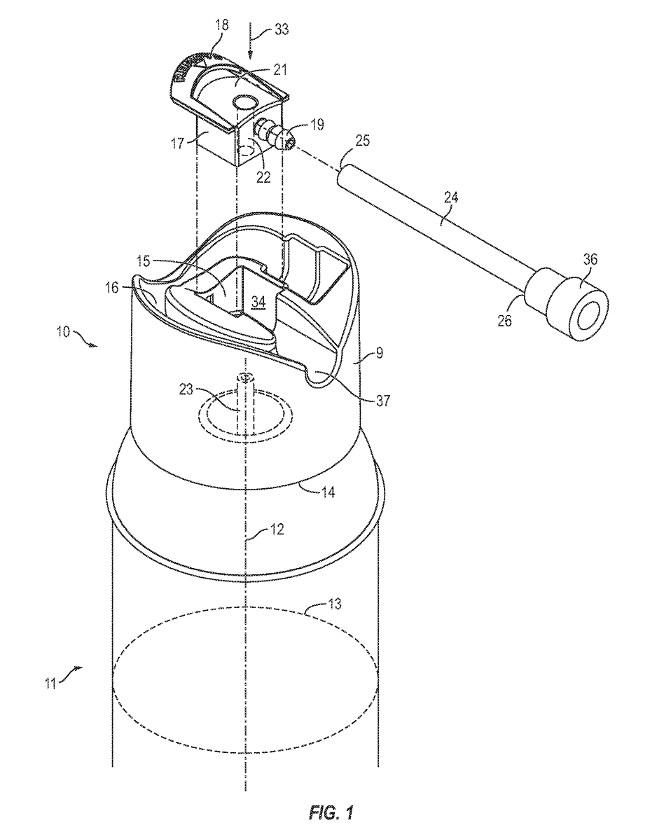

Aerosol discharge assembly 10 can be more readily appreciated by reference to FIG. 1. Aerosol cap 9 is shown fitting upon cylindrically-shaped aerosol can 11, the latter having centrally located longitudinal axis 12 and circular cross-section 13. As noted, cylindrically-shaped aerosol can 11 contains a pressurized fluid such as a tire sealant which is discharged by depressing valve stem 23. Fluid discharged through valve stem 23 is discharged through aerosol cap 9 and more specifically, through actuator 21 as more fully described below.

Aerosol cap 9 is also cylindrically-shaped having longitudinal axis 31 coextensive with longitudinal axis 12 on cylindrically-shaped can 11 and further having circular cross-section 14 as shown. Aerosol cap 9 further comprises open channel 15 located along longitudinal axis 12 exposing valve stem 23 there through. Aerosol cap 9 also is characterized by providing hose receiving channel 16 exposed at its top surface.

Actuator 21 is sized to slip fit within open channel 15. When a user depresses actuator 21 in the direction of arrow 33, sidewalls 17 move downwardly against sidewalls 34 of open channel 15. As valve stem 23 is aligned with fluid input port 22, fluid contained within cylindrically-shaped aerosol can 11, being pressurized, enters actuator 21 at inlet port 22 and travels through actuator 21 and is discharged through fluid outlet port 19.

As the present aerosol discharge assembly is, in its preferred embodiment, intended to discharge a tire sealant for emergency tire repair, it is necessary that the sealant emanating from outlet port 19 be capable of being introduced to a tire valve stem. To accomplish this, flexible hose 24 is employed having first end 25 and second end 26, first end 25 being frictionally fit to outlet port 19 and second end 26 joined to tire valve actuator 36 which is configured to engage a tire valve stem to enable the flow of tire sealant from cylindrically-shaped pressurized can 11 through valve stem 23, actuator 21 and flexible hose 24.

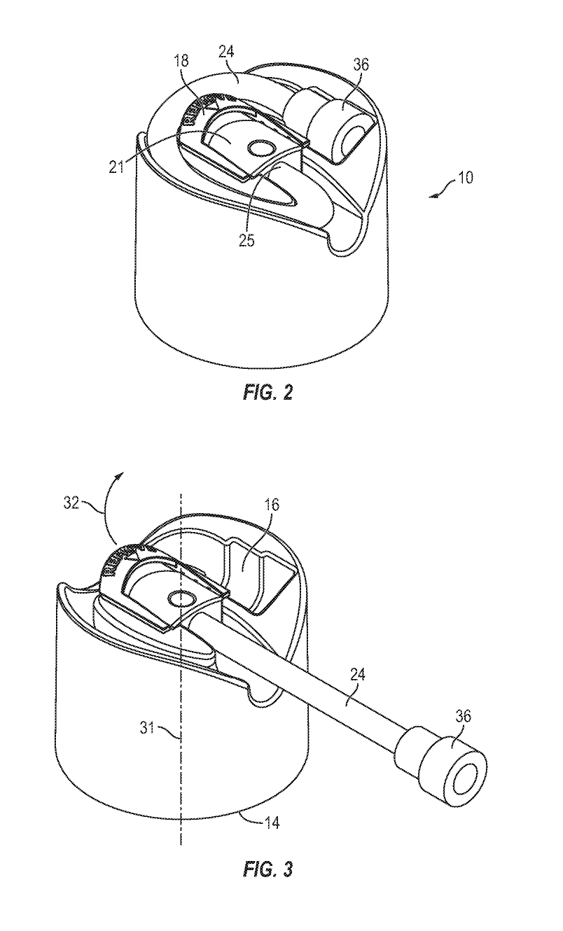

To prevent damage to flexible hose 24 when shipping, warehousing and displaying of the present product, as noted in reference to FIG. 2, flexible hose 24 is sized and configured to frictionally fit within hose receiving channel 16. Thus, when a user intends to employ the aerosol discharge assembly of the present invention, flexible hose 24 would be removed from hose receiving channel 16 through use of one's thumb and forefinger disengaging flexible hose 24 and tire valve actuator 36. Aerosol cap 9 is further characterized as having radial channel 37 exposed a top aerosol cap 9 in alignment with actuator outlet port 19 to facilitate the linear extension of flexible tube 24 from actuator 21 (FIG. 3). If the contents of cylindrically-shaped aerosol can 11 are not fully exhausted during a single use of the present invention, flexible hose 24 can be cleaned and frictionally reinserted within hose receiving channel 16 thus re-creating its FIG. 2 orientation.

As a further safety measure to ensure that fluid contained within cylindrically-shaped aerosol can 11 does not inadvertently discharge there from, safety tab 18 is employed. Safety tab 18 is ideally molded to sidewalls 17 of actuator 21 such that, when in place, actuator 21 is prevented from moving in the direction of arrow 33. As such, when a user intends to employ aerosol discharge assembly 10, safety tab 18 can be lifted in the direction of arrow 32 thus freeing side wall 17 of actuator 21 to move against sidewalls 34 of open channel 15.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. An aerosol discharge assembly comprising:
An aerosol cap sized to frictionally fit atop a cylindrically-shaped aerosol can having a centrally located longitudinal axis and circular cross-section, said cylindrically-shaped aerosol can containing a pressurized fluid therein and a valve stem which, when depressed, discharges said fluid there through, said aerosol cap being cylindrically shaped having a longitudinal axis coextensive with the longitudinal axis of said cylindrically-shaped aerosol can and a circular cross-section, said aerosol cap further comprising an open channel located along said longitudinal axis exposing said valve stem there through and a hose receiving channel exposed atop said aerosol cap;
an actuator sized to slip fit within said open channel and to slide within said open channel when being depressed by a user, said actuator comprising a fluid inlet port sized to frictionally fit said valve stem once said actuator is depressed and a fluid output port in fluid communication with said fluid inlet port such that when said actuator is depressed, pressurized fluid from said aerosol can is caused to enter said fluid inlet port, travel through said actuator and discharge through said fluid outlet port;
a flexible hose having a first end and a second end, said first end being sized to capture said fluid outlet port, said second end comprising a fixture for passing said pressurized fluid there through, said flexible hose being sized to frictionally fit within said hose receiving channel when not in use; and
a safety tab positioned atop and affixed to said actuator which, when in place, prevents said actuator from being depressed within said open channel.

2. The aerosol discharge assembly of claim 1 wherein said fluid comprises tire sealant and said second end of said flexible hose comprises a tire valve actuator which, when applied to a tire valve stem, facilitates the passage of said tire sealant there through.

3. The aerosol discharge assembly of claim 1 wherein said aerosol cap further comprises a radial channel exposed atop said aerosol cap in alignment with said actuator outlet port.

4. (canceled)

5. (canceled)

6. The aerosol discharge assembly of claim 1 wherein said safety tab is a unitary part of said actuator and removable therefrom for enabling said actuator to be depressed for discharging said fluid from said aerosol can to said actuator inlet port.
